(19) United States
(12) Patent Application Publication
(10) Pub. No.: US 2007/0113973 A1
(43) Pub. Date: May 24, 2007

(54) Apparatus, system and method for securing a device and/or a detachable element of the device

(76) Inventors: Christopher Marszalek, Plainfield, IL (US); Daniel Horvath, Plainfield, IL (US)

Correspondence Address: PATENTS+TMS, P.C., 2849 W. ARMITAGE AVE., CHICAGO, IL, 60647, US

(21) Appl. No.: 11/416,152

(22) Filed: May 2, 2006

Related U.S. Application Data
(63) Continuation-in-part of application No. 11/284,276, filed on Nov. 21, 2005.

(51) Int. Cl. B32B 37/00

(52) U.S. Cl. 156/292

(57) ABSTRACT

An apparatus, a system and a method for securing a device and/or a detachable element of a device are provided. The apparatus and the system have a plunger which contacts the device and/or the detachable element. The plunger is connected to the device and/or the detachable element via a first adhesive, a layer and a second adhesive. The layer is positioned between the first adhesive and the second adhesive. The second adhesive attaches to the device and/or the detachable element. A circuit and/or a security system are in communication with the plunger to detect the location of the plunger. Removing the device and/or the detachable element of the device from the housing activates an alarm.

This application is a Continuation-In-Part Application of co-pending U.S. patent application Ser. No. 11/284,276 filed on Nov. 21, 2005.

### BACKGROUND OF THE INVENTION

The present invention generally relates to an apparatus, a system and a method for securing a device and/or a detachable element of the device. More specifically, the present invention relates to an apparatus, a system and a method for securing a device and/or a detachable element of the device which may have a plunger extending from a housing. A circuit may be located and/or may be positioned in the housing. The plunger may be connected to and/or may be in communication with the circuit. One or more flaps may be connected to and/or may extend from the housing. An adhesive layer may be applied to, may be connected to and/or may be removably attached to the flaps. The plunger may move inward and/or outward with respect to the housing. The flaps may contact to and/or may abut the device and/or the detachable element of the device to depress and/or lower the plunger into the housing. Damaging, stealing and/or manipulating the device and/or the detachable element of the device may move the plunger outward with respect to the housing. The circuit may monitor and/or may detect a location and/or a position of the plunger.

It is generally known for, for example, merchants, vendors, retailers and/or wholesalers to display a device to a customer at, for example, a retail store and/or a sales facility for examination and/or inspection by the customer. The device may be a camera, a digital camera, a portable compact disc player, a PDA and/or a cellular telephone. The device is traditionally displayed in conjunction with a fixture, such as, for example, a cabinet, a table, a wall, a column, a shelf and/or the like. Generally, a metal frame surrounds and/or encloses the device. The metal frame is typically heavy and cumbersome. As a result, the frame prevents a user and/or a customer from examining the device and/or a detachable element of of the device. For example, the frame prevents the user and/or customer from, for example, examining the various characteristics of the device, such as, for example, the weight, the texture, the feel, the configuration, the appearance and/or the like. Further, the frame must be unique to a device and/or devices of similar sizes. For example, the frame for a rectangular device is not suitable to fit a circular device.

Still further, the device may have a detachable element, such as, for example, a camera lens, an ear piece, head phones, a head set, a wireless head set, a battery, a speaker, a case to hold the device therein and/or the like. Typically, the metal frame prevents the detachable element from being examined and/or disconnected from the device. Alternatively, the frame may surround the device but fail to secure the detachable element to the fixture. As a result, the detachable element may be damaged, stolen or the like. Moreover, the metal frame may damage the device by, for example, scratching the device. Furthermore, the metal frame may be difficult and/or time consuming to remove from the device.

In addition, a cable typically attaches the frame to the fixture to merely provide mechanical security for the device and/or the detachable element of the device. The cable is usually a steel cable to prevent the device from being stolen and/or taken to a location remote with respect to the fixture. A merchant and/or a retailer must inspect to ensure that the cable is attached to the fixture, that the cable is attached to the frame and that the frame is secured to the device. Generally, physical inspection is required by an employee of the merchant and/or retailer. Therefore, securing a device via a cable and a frame is costly.

A need, therefore, exists for an apparatus, a system and a method for securing a device and/or a detachable element of a device without damaging the device. Additionally, a need exists for an apparatus, a system and a method for securing a device and/or a detachable element of the device which may provide mechanical security and electrical security to the device and/or the detachable element of the device. Further, a need exists for an apparatus, a system and a method for securing the device to a security system which may visibly indicate that the device and/or the detachable element of the device is mechanically secured and/or is electrically secured. Still further, a need exists for an apparatus, a system and a method for securing the device to the security system which may allow a user and/or customer to examine the detachable element of the device.

Moreover, a need exists for an apparatus, a system and a method for securing the device to the security system which may trigger an alarm when the device and/or the detachable element of the device is separated from the security system and/or the housing. Furthermore, a need exists for an apparatus, a system and a method for securing the device to the security system having a circuit to power a light emitting element which may indicate the device and/or detachable element of the device is secure. In addition, a need exists for an apparatus, a system and a method for securing a device with a flap which may adjust to a range of sizes and configurations of devices. In addition, a need exists for an apparatus, a system and a method for securing the detachable element and the device which may adhere to the device and/or the detachable element. Further, a need exists for an apparatus, a system and a method for securing the device and/or the detachable element of the device which may allow a user and/or a customer to examine the detachable element.

### SUMMARY OF THE INVENTION

The present invention relates to an apparatus, a system and a method for securing a device and/or a detachable element of the device. More specifically, the apparatus, the system and the method for securing the device and/or the detachable element of the device may connect to a security system, such as, for example, an alarm box, an alarm board, an alarm and/or the like. The device may be, for example, an electronic device, such as, for example, a camera, a cellular phone, a compact disc player, a remote control, a PDA, a digital musical player, a portable media player or the like. The device may have a detachable element, such as, for example, a battery, a camera lens, an antenna, a carrying case and/or the like. A circuit may be connected to and/or in communication with the security system. The circuit may detect and/or may monitor the device and/or the detachable element via a plunger which may be connected to and/or in communication with the circuit. One or more flaps may connect and/or may attach the plunger may be secure to and/or may be attached to the device and/or the detachable element. A layer of material may be attached to and/or may be secured to the flaps. An adhesive may be applied to and/or may be coated on the layer. Adhering and/or attaching the housing and/or flaps to the device and/or the detachable element may activate the security system.

To this end, in an embodiment of the present invention, an apparatus for securing a device or a detachable element is provided. The apparatus has a housing having walls extending from a bottom surface to a top surface wherein the walls define an interior wherein the bottom surface of the housing contacts the device or the detachable element. Further, the apparatus has a layer having a top surface and a bottom surface wherein the top surface is opposite to the bottom surface wherein the top surface has an adhesive wherein the bottom surface has the adhesive wherein the top surface of the layer adheres to the housing and further wherein the bottom surface of the layer adheres to the device or the detachable element. Still further, the apparatus has a plunger having a length defined between a first end and a second end wherein the plunger extends from the bottom surface of the housing wherein the first end of the plunger contacts device wherein adhering the layer to the device moves the first end of the plunger toward the interior of the housing.

In an embodiment, the apparatus has a flap connected to the housing wherein the layer is attached to the flap wherein the flap connects to the housing to the device or the detachable element.

In an embodiment, the apparatus has a circuit positioned within the interior of the housing wherein the circuit transforms a position of the plunger into a signal.

In an embodiment, the layer is adhered to the housing stronger than the layer is adhered to the device or the detachable element.

In an embodiment, the apparatus has a film attached to the bottom surface of the layer wherein the film is removable to expose the bottom surface of the layer.

In an embodiment, the apparatus has a cable connected to the housing wherein the cable wherein the cable is electrically connected to the interior of the housing.

In another embodiment of the present invention, a system for securing a device or a detachable element of the device is provided. The system has a plunger having a length defined between a first end and a second end wherein the first end contacts the device or the detachable element wherein the plunger moves in at least one direction with respect to the device or the detachable element. Further, the system has a circuit connected to the plunger wherein the circuit transmits a signal based on a position of the plunger wherein the signal is an electrical signal associated with the position of the plunger. Still further, the system has a first flap connected to the plunger wherein the flap has a top surface and a bottom surface wherein the top surface is opposite to the bottom surface. Moreover, the system has a layer connected to the first flap wherein the layer has a thickness defined between a top side and a bottom side wherein the top side of the layer is adhered to the first flap via a first adhesive wherein the bottom side of the layer is adhered to the device or the detachable element of the device via a second adhesive.

In an embodiment, the system has a second flap having a top surface and a bottom surface wherein the top surface is opposite to the bottom surface wherein the layer is adhered to the bottom surface of the second flap.

In an embodiment, the system has a cable connected to the circuit wherein the cable outputs the signal from the circuit.

In an embodiment, the first adhesive is stronger than the second adhesive.

In an embodiment, the system has a light emitting element connected to the plunger wherein the light emitting element illuminates based on a position of the plunger.

In an embodiment, the system has an alarm in communication with the circuit wherein disconnecting the plunger from the device or the detachable element produces a sound from the alarm.

In an embodiment, the system has a liner removably attached to the second adhesive wherein the liner is removed to attach to the second adhesive to the device or the detachable element of the device.

In another embodiment of the present invention, a method for securing a device or a detachable element of the device is provided. The method has the step of providing a housing having peripheral walls defining an interior wherein the housing has a top side and a bottom side wherein the top side is opposite to the bottom side. Further, the method has the step of connecting a flap to the housing wherein the flap extends from the peripheral walls of the housing outward with respect to the interior of the housing wherein the flap has a top surface and a bottom surface wherein the bottom surface is opposite the top surface. Still further, the method has the step of attaching a layer to the flap wherein the layer has a first side and a second side wherein the first side is opposite to the second side wherein the first side has a first adhesive wherein the second side has a second adhesive and further wherein the first side is attached to the bottom surface of the flap. Moreover, the method has the step of attaching the flap to the device or the detachable element of the device so that the housing contacts the device.

In an embodiment, the method has the step of operatively connecting a plunger to the housing wherein the plunger contacts the device or the detachable element and further wherein disconnecting the housing from the device moves the plunger outward with respect to the interior of the housing.

In an embodiment, the method has the step of securing a light emitting element to the housing wherein the light emitting element illuminates based on a position of the device with respect to the housing.

In an embodiment, the method has the step of connecting an alarm to the housing wherein disconnecting the device or the detachable element from the housing activates the alarm.

In an embodiment, the method has the step of connecting a plunger to the device wherein the device or the detachable element depresses the plunger when the flap is attached to the device or the detachable element.

In an embodiment, the method has the step of attaching a film to the second side of the layer wherein the film is removably attached to the layer via the second adhesive.

In an embodiment, the method has the step of connecting a circuit to the interior of the housing wherein the circuit outputs a signal associated with a location of the device or the detachable element of the device.

It is, therefore, an advantage of the present invention to provide an apparatus, a system and a method for securing a device and/or a detachable element of the device which may have a housing having flaps for attaching to the device and/or the detachable element.

Another advantage of the present invention is to provide an apparatus, a system and a method for securing a device and/or a detachable element of the device which may have an electrical circuit connected to the device and/or the detachable element via adhesive.

And, another advantage of the present invention is to provide an apparatus, a system and a method for securing a device which may visibly display that the device and/or a detachable element of the device is electrically attached to a security system.

Yet another advantage of the present invention is to provide an apparatus, a system and a method for securing a device and/or a detachable element of the device which may have flaps with an adhesive layer connected to a cable and/or a security system.

A further advantage of the present invention is to provide an apparatus, a system and a method for securing a device and/or a detachable element of the device which may allow the detachable element to be disconnected from the device without disconnected the detachable element from a security system and/or electrical circuit.

Moreover, an advantage of the present invention is to provide an apparatus, a system and a method for securing a device and/or a detachable element of the device which may be used on a plurality of devices having a plurality of different sizes and/or a plurality of different configurations.

And, another advantage of the present invention is to provide an apparatus, a system and a method for securing a device and/or a detachable element which may be mechanically secured with a cable adhered to the device and/or the detachable element.

Yet another advantage of the present invention is to provide an apparatus, a system and a method for securing a device and/or a detachable element of the device .

Another advantage of the present invention is to provide an apparatus, a system and a method for securing a device and/or detachable element which allows the detachable element of the device to be removed from the device and/or examined by a customer and/or a user.

A still further advantage of the present invention is to provide an apparatus, a system and a method for securing a device and/or a detachable element of the device which may have a cable and/or a housing adhered to the device and/or the detachable element of the device.

Additional features and advantages of the present invention are described in, and will be apparent from, the detailed description of the presently preferred embodiments and from the drawings.

### BRIEF DESCRIPTION OF THE DRAWINGS

FIG. 1 illustrates a top plan view of a housing with a cable, a flap and a light emitting element in an embodiment of the present invention.

FIG. 2 illustrates a bottom plan view of the housing with a cable, a flap and a light emitting element in an embodiment of the present invention.

FIG. 3 illustrates a cross-sectional view of the housing having a flap along line I-I in an embodiment of the present invention.

FIG. 4 illustrates a top plan view of the housing with a cable, flaps and the light emitting element in an embodiment of the present invention.

FIG. 5 illustrates a bottom plan view of the housing with the cable, flaps and the light emitting element in an embodiment of the present invention.

FIG. 6 illustrates a top plan view of the housing with the flap, the cable, a band and the light emitting element attached to a device in an embodiment of the present invention.

FIG. 7 illustrates a top plan view of the housing with flaps, a cable, a band and a light emitting element attached to a device in an embodiment of the present invention.

FIG. 8 illustrates a perspective view of the housing having a flap, a light emitting element and a plunger.

FIG. 9 illustrates a cross-sectional view of a flap having a layer in an embodiment of the present invention.

FIG. 10 illustrates a side plan view of a housing having a flap and a layer in an embodiment of the present invention.

FIG. 11 illustrates a plan box diagram of a system for securing a device and/or a detachable element of the device in an embodiment of the present invention.

FIG. 12 illustrates a flowchart for connecting a flap to a device or a detachable element of the device in an embodiment of the present invention.

### DETAILED DESCRIPTION OF THE PREFERRED EMBODIMENTS

The present invention relates to an apparatus, a system and a method for securing a device and/or a detachable element of the device. More specifically, the apparatus, the system and the method for securing the device and/or the detachable element of the device may mechanically secure the device and/or the detachable element by, for example, adhering and/or attaching a cable to the detachable element and/or the device. In addition, the apparatus, the system and the method for securing the device and/or the detachable element of the device may electrically secure the detachable element and/or the device via a circuit connected to an alarm and/or a security system. The circuit may be housed and/or may be enclosed by a housing. One or more flaps may connect the housing to the device. The flaps may have a layer of adhesive, such as, a foam adhesive for attaching the housing to the device and/or the detachable element of the device.

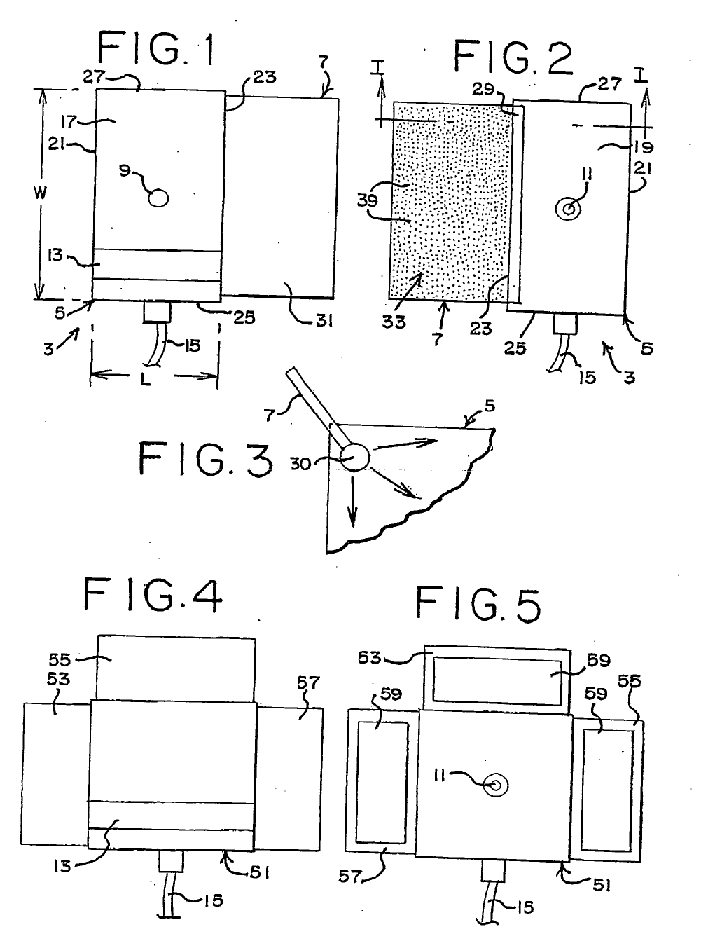

Referring now to the drawings wherein like numerals refer to like parts, FIG. 1 and FIG. 2 illustrate a system 3 and a housing 5 which may have a flap 7, a light emitting element 9, a plunger 11, a recession 13 and/or a cable 15. The housing 5 may be, for example, rectangularly shaped. In another embodiment, the housing 5 may be a different shape, such as, for example, a rectangle, a square, a circle, an octagon and/or the like. It should be understood that the housing 5 may be any shape known to one having ordinary skill in the art. The present invention should not be deemed as limited to the specific shape of the housing 5.

The housing 5 may have a top side 17 and a bottom side 19 wherein the bottom side 19 is opposite to the top side 17. The housing 5 may have a first end 21, a second end 23, a front end 25 and/or a back end 27. The second end 23 is opposite to the first end 21. The front end 25 is opposite to the back end 27. The housing 5 may have a length, L, defined between the first end 21 and the second end 23. The housing 5 may have a width, W, defined between a front end 25 and the back end 27. The housing 5 may have a height, H, defined between the top side 17 and the bottom side 19, as shown in FIG. 8. The top side 17 and/or the bottom side 19 may connect the first end 21 to the second end 23 and/or the front end 25 to the back end 27.

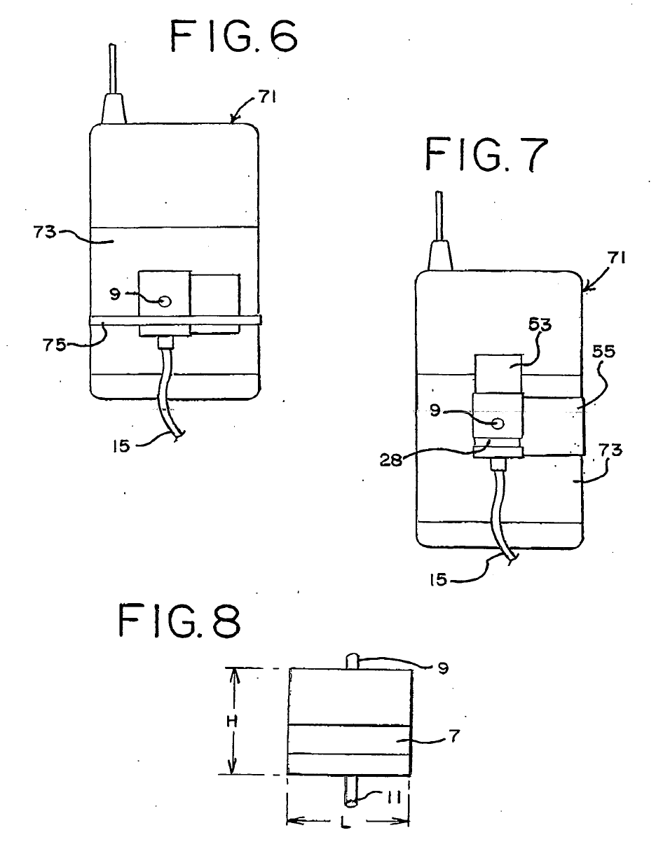

The top side 17 of the housing 5 may have a recession 13. The recession 13 may be, for example, a groove, a slit, a depression and/or the like on the top side 17. The recession 13 may extend from the first end 21 to the second end 23. The recession 13 may be integrally formed to the housing 5. The recession 13 may form a wall 28 defined between the top side 17 and the recession 13, as shown in FIG. 6. The wall 28 may guide and/or hold a band 75, as shown in FIG. 5.

The first end 21, the second end 23, the front end 25 and/or the back end 27 of the housing 5 may have an opening 29, as shown in FIG. 2. The opening 29 may be a slit, an aperture and/or the like. The flap 7 may extend outward from an interior of the housing 5 through the opening 29 to a distance exterior to the housing 5. Alternatively, the flap 7 may be formed to, attached to and/or connected to the first end 21, the second end 23, the front end 25 and/or the back end 27 of the housing 5.

FIG. 3 illustrates a cross-sectional view of the housing 5 having the flap 7 as taken along line I-I in an embodiment of the present invention. The pin 30 may be attached to and/or connected to the flap 7. The pin 30 may be, for example, a rod, a cylinder, a strip and/or the like. The pin 30 may be formed from, for example, plastic, rubber, metal and/or the like. Alternatively, the pin 30 may be integrally formed with the flap 7. The pin 30 may have a length that extends from the top side 17 to the bottom side 19 of the housing 5. The pin 30 may have a diameter greater than a size of the opening 29. The diameter of the pin 30 may prevent the flap 7 from being removed from the housing 5. The flap 7 and/or the pin 30 may move within the housing 5. The pin 30 may freely move within the housing 5. For example, the pin 30 may move toward the opening 29 to move the flap 7 outward with respect to the housing 5.

The flap 7 may have a top surface 31 and/or a bottom surface 33 which may be defined by a length 35 and a width 37 as illustrated in FIG. 1 and FIG. 2. An adhesive 39 may be provided on the bottom surface 33 of the flap 7. The adhesive 39 may be, for example, an epoxy, a glue, an acrylic adhesive, a very high bond adhesive and/or the like. The present invention should not be limited to the specific embodiments of the adhesive. It should be understood that the adhesive 39 may be any adhesive known to one having ordinary skill in the art.

The housing 5 may be made, constructed from and/or formed from a first material, such as, for example, metal, plastic, fiberglass or the like. The plastic may be, for example, a high density polyethylene, a polyvinyl chloride (“PVC”), a polypropylene, an acrylonitrile-butadiene-styrene (“ABS”) plastic and/or the like. The housing 5 may be formed, molded and/or constructed from, for example, one or more pieces and/or sections. The flap 7 may be formed from a second material, such as, for example, rubber, nylon, PVC and/or the like. The second material may be flexible, bendable and/or the like. The second material may adhere to the contours of the device 73, as shown in FIG. 6 and FIG. 7. The first material may be harder than the second material. The present invention should not be deemed as limited to the specific embodiment of the first material or the second material. It should be understood that the first material and the second material may be any materials as known to one having ordinary skill in the art.

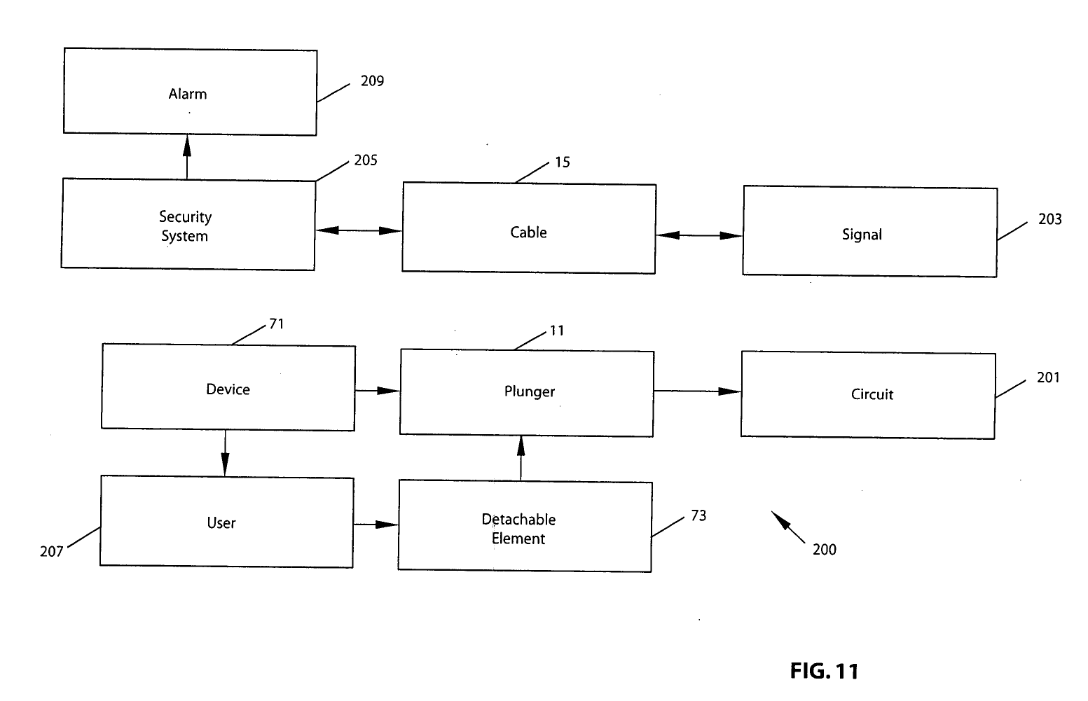

The plunger 11 may be, for example, a lever, a button, a switch and/or the like. The plunger 11 may extend through the bottom side 19 to a first distance exterior to the housing 5. The plunger 11 may depress and/or lower to a second distance within the housing 5. The plunger 11 may be made from, for example, PVC, plastic, rubber, metal and/or the like. The plunger 11 may close and/or may open a circuit 201, as illustrated in FIG. 11, which may activate the light emitting element 9 which may be, for example, a light emitting diode, a light bulb, a laser and/or the like. The plunger 11 may, for example, depress within the housing 5 to close the circuit 201 and/or to activate the light emitting element 9.

The circuit 201 may be within an interior of the housing 5. The circuit 201 may control and/or may activate the light emitting element 9 which may extend from, connect to and/or attach to the top side 21 of the housing 5. The circuit 201 may be electrically connected to and/or operatively attached to the plunger 11. The circuit 201 may attach to and/or may be in communication with a security system 205 which may be an alarm box, an alarm, a computer, a power source and/or the like. The alarm may be, for example, a noise, such as, for example, a beeping noise, a siren noise and/or the like. The circuit 201 may signal and/or activate the security system 205 if the plunger 11 depresses and/or extends to the first distance. A cable 15 may attach and/or may connect the circuit 201 to the security system 205. The cable 15 may be a cord, such as, for example, an electrical cord, a phone line, a cable line, a data line and/or the like. It should be understood that the security system 205 may be any security system known to one having ordinary skill in the art. The present invention should not be deemed limited to the specific embodiments of the security system.

As illustrated in FIG. 4 and FIG. 5, the housing 51 may be square-shaped. The housing 51 may be other shapes, such as, for example, rectangular, triangular, octagonal, circular and/or the like. The housing 51 may have a first flap 53, a second flap 55 and/or a third flap 57. The present invention should not be deemed limited to a specific shape of the housing 51 and/or a specific number of flaps.

The flaps 53,55,57 may have a layer 59. The layer 59 may be, for example, a removable layer on top of the adhesive 39. The adhesive 39 may be, for example, film tape, pressure sensitive adhesive tape, acrylic tape and/or the like. The layer 59 may peel, may pull and/or may be separated from the adhesive 39 which may be located on one or more of the flaps 53, 55, 57. The layer 59 may cover, may protect and/or may shield the adhesive 39.

As illustrated in FIG. 6 and FIG. 7, the housing 5 may be attached to, may be connected to and/or may be secured to the device 71. The device 71 may be, for example, an electronic device, an input device, an output device, a portable media storage unit, a portable electronic device and/or the like. The portable electronic device may be, for example, a camera, a laptop, a personal digital assistant, a cellular phone, a two-way radio, a computer mouse, a portable media player and/or the like. The portable media player may be, for example, a digital video disc (“DVD”) player and/or the like. It should be understood that the device 71 may be any device known to one having ordinary skill in the art. The present invention should not be deemed limited to a specific device.

A detachable element 73 may be attached to and/or connected to the device 71. The detachable element 73 may be a component of the device 71, such as, for example, a lens of a camera, a battery of a cell phone, a disk drive of a computer, an antenna of a personal digital assistant and/or the like. The detachable element 73 may be a product sold and/or purchased with the device 71, such as, for example, a camera case for a camera, a cover for a speaker, a holster for a cellular phone and/or the like. It should be understood that the detachable element 73 may be any detachable element known to one having ordinary skill in the art. The present invention should not be deemed limited to a specific detachable element.

The housing 5 may have flaps 53,55 which may be attached to and/or secured to the detachable element 73 and/or to the device 71. The flaps 53,55 may wrap around an edge and/or a surface of the device 71 so that the device 71 and/or the detachable element 73 may be manipulated and/or examined by a user. A band 75 may be attached to, connected to and/or on top of the recession 13 of the housing 5. The band 75 may be made from rubber, plastic, metal and/or the like. The band 75 may be, for example, a rubber band, a string, a wire and/or the like. It should be understood that the band 75 may be any band known to one having ordinary skill in the art. The present invention should not be deemed limited to a specific band.

The housing 5 may secure to the device 71 and/or the detachable element 73 to depress the plunger 11. The plunger 11 may close the circuit 201 which may activate the light emitting element 9. The cable 15 may power the light emitting element 9 and/or may transmit a signal to the security system 205, as illustrated in FIG. 11. The security system 205 may be, for example, an alarm box, an alarm board, an alarm and/or the like.

In use, a user and/or a customer may manipulate the device 71 and/or the detachable element 73 by, for example, lifting, turning, feeling and/or the like. The device 71 and/or the detachable element 73 may be examined by the user and/or the customer without the flaps 53,55 separating from the device 71 and/or the detachable element 73. The device 71 and/or the detachable element 73 may be examined by the user and/or the customer without the plunger 11 moving outward with respect to the housing 5 to the first distance. If the user attempts to steal and/or to remove the device 71 to a location not desired by a merchant, a retailer and/or the like, the housing 5 may be detached, removed and/or lifted from the device 71 and/or the detachable element 73. As a result, the plunger 11 may move outward with respect to the housing 5 to the first distance which may open the circuit 201 and activate the security system 205 which may have an alarm 209, as illustrated in FIG. 11. For example, the circuit 201 may open to activate the alarm 209, which may produce a noise to signal to the merchant and/or retailer that the device 71 is being stolen. Alternatively, the plunger 11 may move outward with respect to the housing 5 to the first distance which may close the circuit 201 to activate the. security system 205, which may have an alarm 209.

The housing 5 may have, for example, the flaps 53,55 if the merchant desires to secure the device 71 and the detachable element 73. The merchant and/or the retailer may use the housing 5 having the flap 7 if the merchant desires to secure the device 71 or the detachable element 73. Alternatively, the merchant may use the housing 5 having the flaps 53,55 to secure the device 71 or the detachable element 73 where the device 71 or the detachable element 73 requires the flaps 53,55 to adequately secure the housing 5.

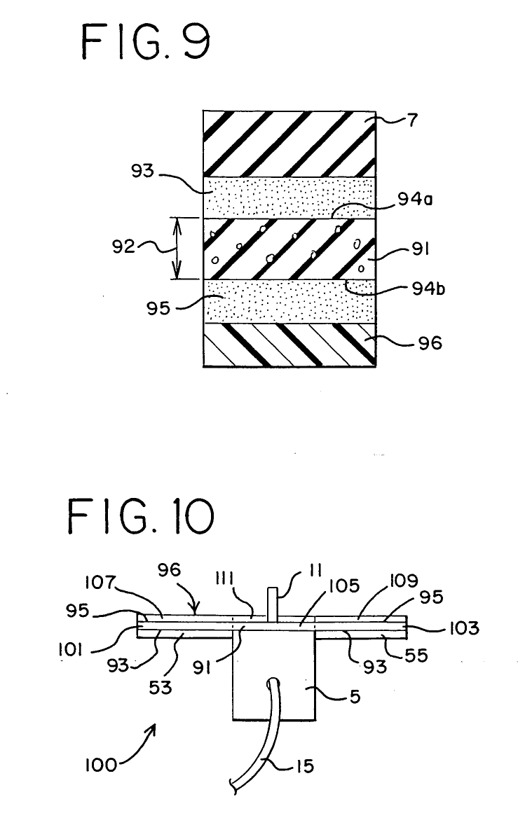

FIG. 9 illustrates a cross-sectional view of the flap 7 in an embodiment of the present invention. A layer 91 may be connected to, may be secured to and/or may be adhered to the flap 7. The layer 91 may be, for example, a substrate, such as, for example, foam, acrylic, acrylic foam, polycarbonate, polystyrene, polyethylene, polypropylene, silicone, teflon, nylon, plastic, metal, ceramic, and/or the like. The layer 91 may have a thickness 92 defined between a top surface 94a and a bottom surface 94b of the layer 91.

A first adhesive 93 and/or a second adhesive 95 may be connected to and/or attached to the first layer. In an embodiment, the first adhesive 93 and/or the second adhesive 95 may be coated on and/or may be applied on the first layer 91. The first adhesive 93 and/or the second adhesive 95 may be, for example, a water based adhesive, a thermal adhesive, a moisture cure adhesive, an ultraviolet cure adhesive, a cyanoacrylate adhesive, an anaerobic adhesive, a film adhesive and/or the like. The water based adhesive may be, for example, a resin cement, a latex cement, a vegetable glue and/or the like. The thermal adhesive may be, for example, a wax, an epoxy, a polyurethane adhesive, an acrylic adhesive, a silicone adhesive and/or the like. The moisture cure adhesive may be, for example, silicone, polyurethane and/or the like. The moisture cure adhesive may be cured to adhere to the device 71, the detachable element 73 and/or the first layer 91. In an embodiment, the moisture cure adhesive may be cured with, for example, moisture, such as, for example, water, isopropyl alcohol and/or the like.

The first adhesive 93 may be located and/or may be positioned between the flap 7 and the layer 91. The second adhesive 95 may be located and/or may be positioned between the layer 91 and the device 71 and/or the detachable element 73. In addition, a film 96 may be connected to and/or removably attached to the second adhesive 95. The second adhesive 95 may be located and/or may be positioned between the film 96 and the layer 91.

Furthermore, the second adhesive 95 may have different properties and/or characteristics with respect to the first adhesive 93. In an embodiment, the first adhesive 93 may provide, for example, a stronger bond to the layer 91 than the second adhesive 95. To this end, the second adhesive 95 may be separated and/or may be detached from the device 71 and/or the detachable element 73 without separation of the first adhesive 93 from the flap 7 and/or the layer 91. In such a case, the flap 7 and the layer 91 may be detached from the device 71 and/or the device 73.

Alternatively, the second adhesive 95 may have, for example, a stronger bond to the layer 91 than the first adhesive 93. To this end, the first adhesive 93 may be separated from and/or may be detached from the layer 91 without separation of the second adhesive 95 from the layer 91. In such a case, the flap 7 may be detached from the layer 91 which may remain attached to the device 71 and/or the detachable element 73. The layer 91 may be removed from the device 71 and/or the detachable element 73.

If the layer 91 is separated and/or disconnected from the device 71 and/or the detachable element 73, then the layer 91 may be, for example, discarded. Alternatively, the first adhesive 93 and/or the second adhesive 95 may be, for example, re-applied onto the layer 91. The system 3 and/or the flap 7 may be re-used by, for example, applying the layer 91 having the first adhesive 93, the second adhesive 95 and/or the film 96 to the flap 7, the device 71 and/or the detachable element 73. In addition, the second adhesive 95 may be re-applied, re-attached and/or reconnected to the layer 91. The second adhesive 95 may then attach and/or adhere to the device 71 and/or the detachable element 73. To this end, the system 3 may be reusable.

The film 96 may be connected to and/or may be removably attached to the second adhesive 95. The film 96 may be, for example, a laminate, a liner, an acrylic tape and/or the like. The film 96 may be transparent and/or translucent. In addition, the film 96 may maintain the second adhesive 95 by, for example, preventing the second adhesive 95 from contacting moisture, from adhering to another device and/or from otherwise diminishing adhesive qualities of the second adhesive 95. For example, the film 96 may be removed and/or may be detached to secure the second adhesive 95 to the device 71 and/or the detachable element 73. To this end, the film 96 may protect and/or may maintain the second adhesive 95 prior to attaching the system 3 and/or the flap 7 to the device 71 and/or the detachable element 73. Removing the film 96 may expose the second adhesive 95.

FIG. 10 illustrates a side plan view of a system 100 in an embodiment of the present invention. The cable 15 may be connected to and/or attached to the housing 5. The first flap 53 and/or the second flap 55 may be connected to and/or may be attached to the housing 5. The first flap 53 and/or the second flap 55 may extend outward with respect to the housing 5. The plunger 11 may extend from the housing 5. The plunger 11 may extend, for example, perpendicularly, to the first flap 53 and/or the second flap 55. The first flap 53 and/or the second flap 55 may be movable toward and/or away from the plunger 11.

The layer 91 may be secured to, may be adhered to and/or may be attached to the first flap 53, the second flap 55 and/or the housing 5. The layer 91 may have a first portion 101, a second portion 103 and/or a third portion 105. The first portion 101 may be attached to and/or adhered to the first flap 53. The second portion 103 may be attached to and/or adhered to the second flap 55. Further, the third portion 105 may be adhered to and/or attached to the housing 5. Alternatively, the first portion 101, the second portion 103 and the third portion 105 may be integrally formed. The plunger 11 may extend from the housing 5 and through the third portion 105 of the layer 91.

The first adhesive 93 may adhere and/or may attach the layer 91 to the first flap 53, the second flap 55 and/or the housing 5. The second adhesive 95 may be applied to and/or may be coated on the layer 91. The film 96 may be attached to and/or may be connected to the second adhesive 95. In addition, the film 96 may have a first section 107, a second section 109 and/or a third section 111. The first section 107 may be connected to and/or removably attached to the first portion 101 of the layer 91; the second section 109 may be connected to and/or removably attached to the second portion 103 of the layer 91; and the third section 111 may be connected to and/or removably attached to the third portion 105 of the layer 91. Alternatively, the film 96 may be integrally formed and may removably attach to the first portion 101, the second portion 103 and the third portion 105.

FIG. 11 illustrates a black box diagram of a system 200 in an embodiment of the present invention. The system 200 may have the plunger 11 which may contact, may abut and/or may be in communication with the device 71 and/or the detachable element 73. The housing 5 may be attached to and/or connected to the device 71 and/or the detachable element 73 to depress and/or to move the plunger 11 inward with respect to the housing 5.

In an embodiment, the first flap 53 may attach to the device 71 and the second flap 55 may attach to the detachable element 73 of the device 71. The fist flap 53 and the second flap 55 may, for example, mechanically secure the device via the cable 15. The first flap 53 and the second flap 55 may position the plunger 11 on the device 71 and/or the detachable element 73. The plunger 11 may move inward with respect to the housing 5. Moving the plunger 11 may contact and/or may communicate with the circuit 201. The plunger 11 may be connected to and/or in communication with the circuit 201 to indicate, for example, a position of the plunger 11.

The circuit 201 may be, for example, an electrical circuit. In an embodiment, the plunger 11 may open, may close, may activate and/or may engage the circuit 201. In addition, the circuit 201 may monitor and/or may detect, for example, a location and/or a position of the plunger 11. The circuit 201 may output a signal 203 which may be, for example, an electrical signal, a radio signal, a data signal and/or the like. The circuit 201 may transmit and/or may send the signal 203 to the security system 205 via the cable 15. The signal 203 may correspond to and/or may be associated with a location of and/or a position of the plunger 11. The signal 203 may be transmitted to and/or may be received by the security system 205.

The security system 205 may be, for example, an alarm system, an alarm board, an alarm box and/or the like. The security system 205 may interpret and/or may associate the signal 203 with a position and/or with a location of the plunger 11. To this end, the security system 205 may detect and/or may track movement of the plunger 11. Accordingly, the security system 205 may monitor and/or may detect movement of the device 71 and/or the detachable element 73. In addition, the security system 205 may track and/or may store the signal 203 received from the cable 15. To this end, the security system 205 may store and/or may monitor, for example, a number of times in which the plunger 11 moved.

A user 207 may inspect, may manipulate and/or may operate the device 71 and/or the detachable element 73 of the device 71. The user 207 may be, for example, a customer, a potential purchaser and/or the like. Alternatively, the user 207 may be, for example, a thief. The user 207 may attempt to remove the device 71 and/or the detachable element 73 from the cable 15, the housing 5, the first flap 53 and/or the second flap 55. Removing the device 71 and/or the detachable element 73 from, for example, the housing 5 may move the plunger 11. In an embodiment, the plunger 11 may move outward with respect to the. housing 5. The circuit 201 may detect the movement of the device 71 and/or the housing 5. The circuit 201 may send and/or may transmit the signal 203 to the security system 205 via the cable 15.

The security system 205 may be connected to and/or may be in communication with the alarm 209. Separating the device 71 and/or the detachable element 73 from the housing 5 and/or the flaps 53, 55 may trigger and/or may activate the alarm 209. For example, the plunger 11 move outward with respect to the housing 5, and, as a result, the circuit 201 may send the signal 203 to the security system 205 to activate the alarm 209. To this end, the alarm 209 may produce, for example, an audio signal, a visual signal, a data signal and/or the like. The audio signal may be, a sound, such as, for example, a horn, a siren, a spoken voice, a beeping sound and/or the like. The visual signal may be, for example, a light, such as, for example, a strobe light, a flashing light, a rotating light and/or the like. The data signal may be, for example, information of a location of the user 207, information relating do the device 71 and/or the detachable element 73 and/or the like. The data signal may be transmitted and/or may be sent to, for example, a security company, police officers and/or the like.

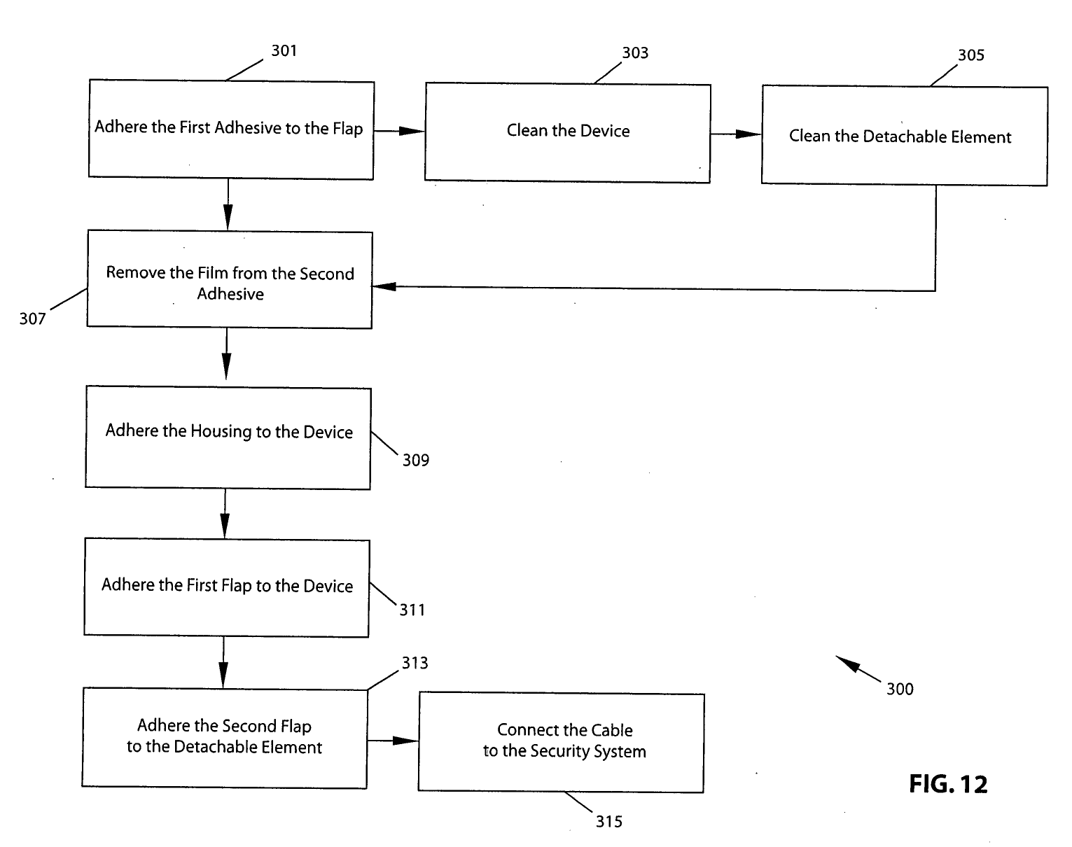

FIG. 12 illustrates a flowchart 300 of an embodiment of the present invention. The user 207, as illustrated in FIG. 11, may be, for example, an individual securing the device 71, such as, for example, an employee of a retail establishment, a merchant and/or an employee of a security company. The user 207 may adhere the first adhesive 93 to the first flap 53 and/or the second flap 55 as shown at step 301. The user 207 may press and/or may apply pressure to the first adhesive 93 as applying the first adhesive 93 to the first flap 53 and/or the second flap 55. The first adhesive 93 may adhere to the flap 7 in relation to, for example, an amount of pressure applied to the first adhesive 93.

The user 207 may clean the device 71 and/or the detachable element 73, as shown at steps 303 and 305, respectively. Cleaning the device 71 and/or the detachable element 73 may provide, for example, a clean surface to apply the second adhesive 95. In an embodiment, the device 71 and/or the detachable element 73 may be cleaned by, for example, a solution, such as, for example, a mixture of water and isopropyl alcohol. Further, the device 71 and/or the detachable element 73 may be cleaned by, for example, a degreaser, a solvent-based cleaner and/or the like which may remove oil and/or grease from the device 71 and/or the detachable element 73.

The user 207 may remove the film 96 from the second adhesive 95 as shown at step 307. The film 96 may be located and/or may be positioned on the second adhesive 95 of the. housing 5 and/or the flap 7. The housing 5, the first flap 53 and/or the second flap 55 may be connected to the film 96 via the first adhesive 93. The film 96 may be removed and/or detached from the second adhesive 95 to, for example, expose the second adhesive 95. The first flap 53, the second flap 55 and/or the housing 5 may be adhered and/or may be attached to the device 71 and/or the detachable element 73 via the second adhesive 95 as illustrated at steps 309, 311 and 313, respectively. The second adhesive 95 may be pressed and/or may be pushed onto the device 71 and/or the detachable element 73. Adhering the housing 5 to the device 71 and/or the detachable element 73 may position the plunger 11 between the housing 5 and the detachable element 73. The plunger 11 may abut the device 71 and/or the detachable element 73 to depress and/or to move the plunger 11 into the housing 5.

The cable 15 may be connected to the security system 205 as shown at step 315. Detaching the cable 15 from the security system 205 may activate and/or may trigger the alarm 209. To this end, the device 71 and/or the detachable element 73 may be electronically secured via the security system 205.

The device 71 and/or the detachable element 73 of the device 71 may be connected to the housing 5 via the cable 15. The first flap 53, the second flap 55 and/or the third flap 57 may be attached to and/or may be connected to the housing 5. The first adhesive 93 may connect and/or may attach the layer 91 to the flaps 53, 55, 57. The second adhesive 95 may be applied to and/or may be coated on the layer 91. The film 96 may be removed from and/or may be detached from the second adhesive 95 to attach and/or to connect the flaps 53, 55, 57 to the device 71 and/or the detachable element 73. The housing 5 may abut and/or may contact the device 71 and/or the detachable element 73 to depress the plunger 11. The circuit 201 and/or the security system 205 may be connected to and/or in communication with the plunger 11. Removing the device 71 and/or the detachable element 73 from the housing 5 and/or the cable 15 may activate, may sound and/or may trigger the alarm 209.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. An apparatus adhering to a device, the apparatus comprising:
a housing having walls extending from a bottom surface to a top surface wherein the walls define an interior;
a layer having a top surface and a bottom surface wherein the top surface is opposite to the bottom surface wherein the top surface and the bottom surface have an adhesive wherein the top surface of the layer adheres to the bottom surface of the housing; and
a plunger having a length defined between a first end and a second end wherein the first end of the plunger is connected to the interior of the housing wherein the plunger extends outward from the housing to the second end wherein the plunger is movable with respect to the interior of the housing.

2. The apparatus of claim 1 further comprising:
a flap connected to the housing wherein the top surface of the layer is attached to the flap wherein the flap extends outward from the housing.

3. The apparatus of claim 1 further comprising:
a circuit positioned within the interior of the housing wherein the circuit transmits a signal based on a position of the plunger.

4. The apparatus of claim 1 wherein the adhesive on the top surface of the layer is stronger than the adhesive on the bottom surface of the layer.

5. The apparatus of claim 1 further comprising:
a film attached to the bottom surface of the layer wherein the film is removable to expose the bottom surface of the layer.

6. The apparatus of claim 1 further comprising:
a cable connected to the housing wherein the cable is electrically connected to the interior of the housing.

7. A system for securing a device, the system comprising:
a plunger having a length defined between a first end and a second end wherein the first end contacts the device wherein the plunger moves in at least one direction with respect to the device;
a circuit connected to the plunger wherein the circuit transmits a signal based on a position of the plunger wherein the signal is an electrical signal associated with the position of the plunger;
a first flap connected to the plunger wherein the flap has a top surface and a bottom surface wherein the top surface is opposite to the bottom surface; and
a layer connected to the first flap wherein the layer has a thickness defined between a top side and a bottom side wherein the top side of the layer is adhered to the first flap via a first adhesive wherein the bottom side of the layer is adhered to the device via a second adhesive.

8. The system of claim 7 further comprising:
a second flap having a top surface and a bottom surface wherein the top surface is opposite to the bottom surface wherein the layer is adhered to the bottom surface of the second flap.

9. The system of claim 7 further comprising:
a cable connected to the circuit wherein the cable outputs the signal from the circuit.

10. The system of claim 7 wherein the first adhesive is stronger than the second adhesive.

11. The system of claim 7 further comprising:
a light emitting element connected to the plunger wherein the light emitting element illuminates based on a position of the plunger.

12. The system of claim 7 further comprising:
an alarm in communication with the circuit wherein disconnecting the plunger from the device produces a sound from the alarm.

13. The system of claim 7 further comprising:
a liner removably attached to the second adhesive wherein the liner is removed to attach to the second adhesive to the device.

14. A method for securing a device, the method comprising the steps of:
providing a housing having peripheral walls defining an interior wherein the housing has a top side and a bottom side wherein the top side is opposite to the bottom side;
connecting a flap to the housing wherein the flap extends from the peripheral walls of the housing outward with respect to the interior of the housing wherein the flap has a top surface and a bottom surface wherein the bottom surface is opposite the top surface;
attaching a layer to the flap wherein the layer has a first side and a second side wherein the first side is opposite to the second side wherein the first side has a first adhesive wherein the second side has a second adhesive and further wherein the first side is attached to the bottom surface of the flap; and
attaching the flap to the device so that the housing contacts the device.

15. The method of claim 14 further comprising the step of:
operatively connecting a plunger to the housing wherein the plunger contacts the device and further wherein disconnecting the housing from the device moves the plunger outward with respect to the interior of the housing.

16. The method of claim 14 further comprising the step of:
securing a light emitting element to the housing wherein the light emitting element illuminates based on a position of the device with respect to the housing.

17. The method of claim 14 further comprising the step of:
connecting an alarm to the housing wherein disconnecting the device from the housing activates the alarm.

18. The method of claim 14 wherein the device is a detachable element wherein the detachable element is a removable component of the device.

19. The method of claim 14 further comprising the step of:
attaching a film to the second side of the layer wherein the film is removably attached to the layer via the second adhesive.

20. The method of claim 14 further comprising the step of:
connecting a circuit to the interior of the housing wherein the circuit outputs a signal associated with a location of the device.
